(19) United States
(12) Patent Application Publication
(10) Pub. No.: US 2011/0133585 A1
(43) Pub. Date: Jun. 9, 2011

(54) SECURITY IMPROVED SEALED ELECTRIC MACHINE

(76) Inventor: Klaus Langenbacher, Weingarten (DE)

(21) Appl. No.: 12/958,568

(22) Filed: Dec. 2, 2010

(30) Foreign Application Priority Data
Dec. 7, 2009 (EP) 09178198.9

(51) Int. Cl. H02K 5/124

(52) U.S. Cl. 310/88

(57) ABSTRACT

A security-improved sealed electric machine includes a casing (2) housing a stator (3) and a rotor (4) supported by a rotor shaft (5) coming out from the casing (2). Between the casing (2) and the rotor shaft (5), seal rings (7) are provided for sealing the casing interior against the outer environment. Emergency seal rings (10) between the casing (2) and the rotor shaft (5) can assume a deactivated configuration during normal operation of the electric machine and an activated configuration in case of failure of the seal rings (7).

This application claims priority under 35 U.S.C. §119 to European Application No. 09178198.9, filed 7 Dec. 2009, the entirety of which is incorporated by reference herein.

### BACKGROUND

1. Field of Endeavor

The present invention relates to a security-improved sealed electric machine; in particular, the present invention refers to a large sealed electric generator.

2. Brief Description of the Related Art

With reference to FIG. 1, sealed electric generators 1 are known to include a casing 2 housing a stator 3 and a rotor 4 supported by a rotor shaft 5 via bearings 6.

In addition, in order to seal the inside of the casing 2 against the outer environment, seal rings 7 (one at the driven end and another at the non driven end of the rotor shaft 5) are provided between the casing 2 and the rotor shaft 5.

Moreover, typically wipers 8 are provided between the bearings 6 and seal rings 7, to contribute to the sealing effect.

The seal rings 7 are connected to a supply circuit (not shown) that feeds oil therein such that sealing is guaranteed.

Nevertheless, in case a problem at the seal ring supply circuit occurs, sealing cannot be guaranteed anymore and the gas contained inside of the casing 2 partly enters the seal rings and the supply circuit and usually reaches an oil collection chamber of the supply circuit, and partly is discharged via the wipers 8 to the outside of the casing 2.

Since typically the gas contained inside of the casing 2 is H₂, very dangerous, explosive mixtures may generate.

### SUMMARY

One of numerous aspects of the present invention includes a security improved sealed electric machine by which the aforementioned problems of the known art are addressed.

Another aspect of the invention includes a machine whose operation is secure also in case of failure of the seal rings and/or seal ring supply circuit, because formation of explosive mixtures (such as H₂/air mixtures) can be prevented.

### BRIEF DESCRIPTION OF THE DRAWINGS

Further characteristics and advantages of the invention will be more apparent from the description of a preferred but non-exclusive embodiment of a machine according to the invention, illustrated by way of non-limiting example in the accompanying drawings, in which:

FIG. 1 is a schematic view of a traditional electric machine such as a large electric generator;

FIG. 2 is a partial schematic view of an electric machine such as a large electric generator in an embodiment of the invention;

FIGS. 3 and 4 illustrate portions of a machine with an emergency seal ring in an embodiment of the invention activated and deactivated, respectively; and

FIGS. 5 and 6 illustrate two different embodiments of emergency seal rings.

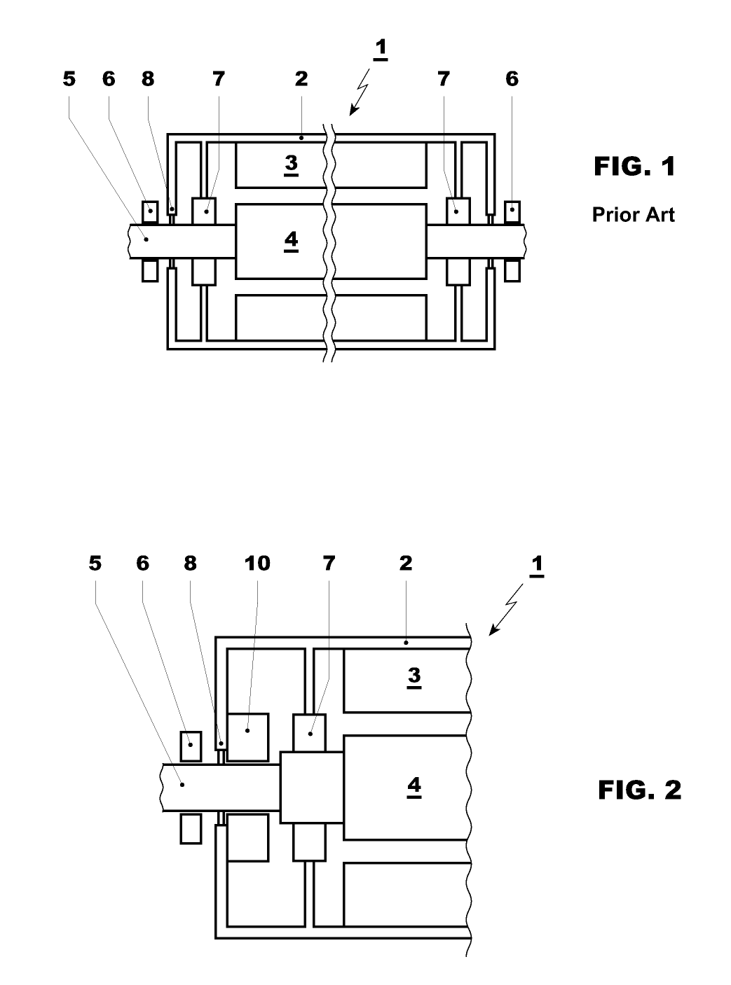

### DETAILED DESCRIPTION OF EXEMPLARY EMBODIMENTS

Security-improved sealed electric machines embodying principles of the present invention have some features in common with traditional sealed electric machines, for this reason like reference numerals already used with reference to traditional electric machines are used to refer to like elements throughout.

The sealed electric machine 1 includes a casing 2 housing a stator 3 and a rotor 4 supported by a rotor shaft 5 coming out from the casing 2.

Between the casing 2 and the rotor shaft 5, seal rings 7 are provided for sealing the casing interior against the outer environment.

These seal rings 7 are preferably usual seal rings, such as for example single, double or triple circuit seal rings; it is clear that the seal rings may also be different from the particular type of seal rings cited.

In addition, bearings 6 for supporting the rotor shaft 5 and wipers 8 contributing to the sealing are provided; wipers 8 are provided between the bearings 6 and the seal rings 7.

Advantageously, emergency seal rings 10 are provided between the casing 2 and the rotor shaft 5 that may assume a deactivated configuration or an activated configuration.

In particular, during normal operation of the electric machine the emergency seal rings 10 assume a deactivated configuration (shown for example in FIG. 4), such that during normal operation the emergency seal rings are not operative and do not carry out any sealing effect and do not affect the electric machine operation.

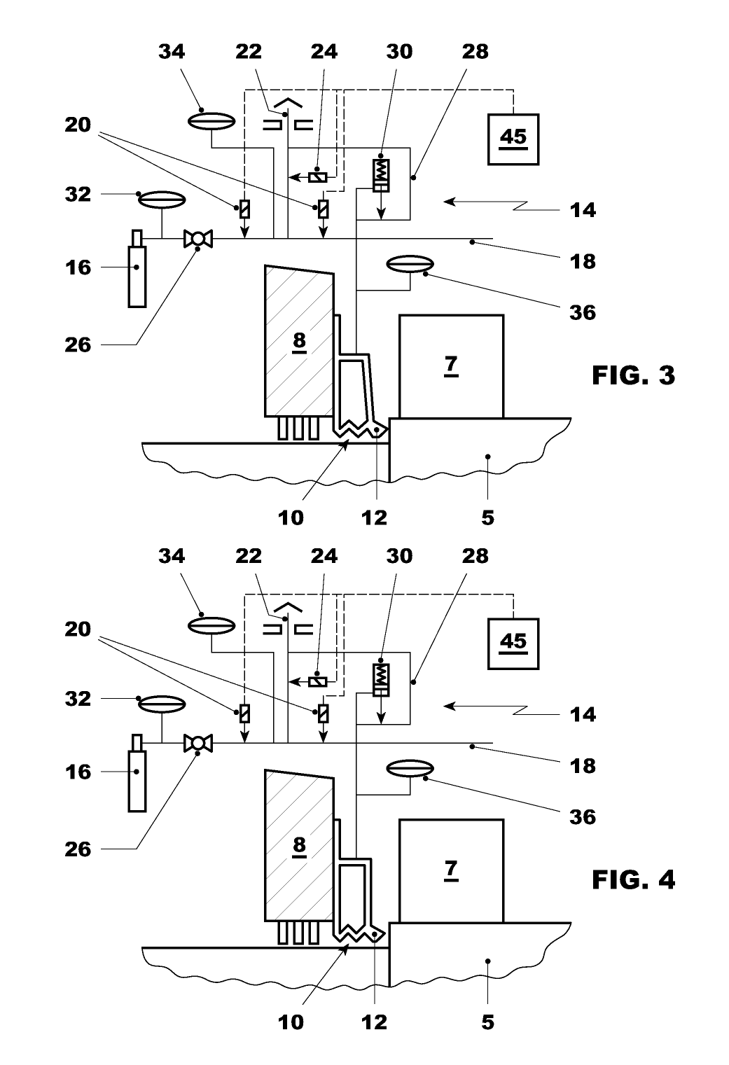

In contrast, in case of failure of the seal rings 7 (i.e., if a failure at the seal rings that during normal operation guarantee the sealing occurs), the emergency seal rings 10 may assume an activated configuration (shown for example in FIG. 3), in which they are operative and guarantee the sealing in addition or instead of the seal rings 7.

In particular, two emergency seal rings 10 are provided, each located at one of the rotor shaft ends.

As shown in the figures, the emergency seal rings 10 may be connected to the wipers 8.

The emergency seal rings 10 have a part 12 that, when the ring 10 is activated, can be moved against the rotor shaft 5 to realize the sealing.

An emergency seal circuit 14, arranged to supply a pressurized gas that causes the movable part 12 to move against the rotor shaft 5, is provided.

The emergency seal circuit 14 includes a tank 16 (such as a pressurized bottle filled with N₂ or argon at 40 bar or higher pressure) containing the pressurized gas and a pipe 18 connecting the tank 16 to the emergency seal rings 10 (FIGS. 3 and 4 only show one seal ring, nevertheless it is clear that a second seal ring is connected at the end of the pipe 18).

Moreover, control valves 20 are provided on the pipe 18, in order to control the gas supply to the emergency seal rings 10; control valves 20 are, for example, solenoid activated valves connected to the plant battery.

In particular, the control valves 20 are two in number and a discharge branch 22 is connected to the pipe 18 between the two control valves 20; the discharge branch 22 is arranged to discharge to the outside of the pipe 18 gas that could leakage through the valve 20 facing the tank 16.

A further control valve 24 is provided on this discharge branch 22; also valve 24 preferably is a solenoid activated valve connected to the plant battery.

Preferably control valves 20 are solenoid valves having an open configuration without energy supply, and the further control valve 24 is a solenoid valve having a closed configuration without energy supply. These valves let the system be activated in case a failure occurs and they do not receive any electric power supply.

If the configuration so requires, a pressure reducing valve 26 may also be provided between the tank 16 and the control valves 20.

Moreover, also a safety discharge branch 28 connected to a portion of the pipe 18 downstream of the control valves 20 is provided; also this safety discharge branch 28 is provided with a safety valve 30.

In addition, pressure sensors 32, 34 and 36 are provided respectively between the tank 16 and the control valves 20, between the two control valves 20 and downstream of the two control valves 20.

These pressure sensors 32, 34, 36 let the system be monitored and the valves 24 and 30 and be driven in case of leakages at the control valve 20 facing the tank 16 or if the pressure in the pipe 18 exceeds a security value.

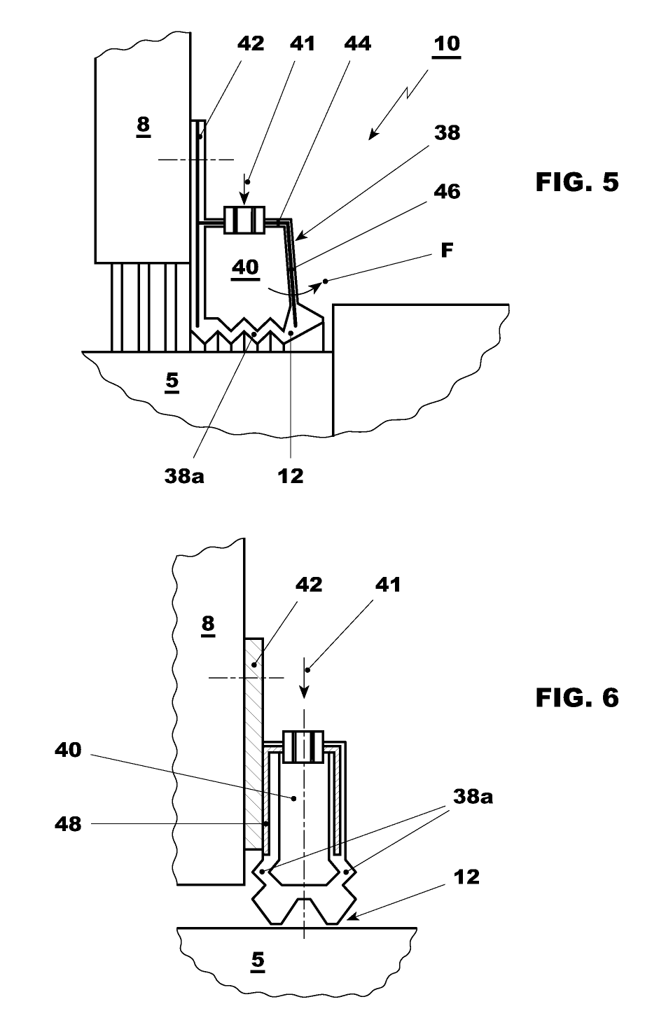

FIG. 5 shows an embodiment of the emergency seal rings 10.

The emergency seal rings 10 have an annular hollow body 38 defining a chamber 40 and the movable part 12.

The chamber 40 is arranged to receive the gas 41 coming from the tank 16 to cause the movable part 12 to be activated and to be moved towards the rotor shaft 5.

In particular, the body 38 is made of a deformable material such as an elastomeric material and has a part 38a towards the rotor shaft 5 with an accordion-like structure.

The other sides include a reinforcing structure made of metal plates, for example made of steel, embedded therein.

In this respect, metal plates 42, 44 are embedded in the side facing the wipers 8 and the side opposite the accordion like part 38a; these metal plates are connected to each other, for example, are welded.

A further metal plate 46 is embedded in the side opposite the wipers 8; this plate 46 is connected to the metal plate 44 (for example it is welded to the plate 44 or the plates 44 and 46 are manufactured in one piece) and defines a spring element that rotates as shown by arrow F when the pressurized gas 41 is introduced into the chamber 40, and moves back to its reset position when the chamber 40 is depressurized.

Thus, when the metal plate 46 rotates as indicated by the arrow F, the movable part 12 is axially pressed against the rotor shaft 5.

FIG. 6 shows a different embodiment of the emergency seal rings, that lets the movable part 12 be radially moved against the rotor shaft 5.

This emergency seal ring of FIG. 6 is similar to the embodiment already described with reference to FIG. 5; in particular it has a metal plate structure 48 embedded in an annular hollow body 38 defining the chamber 40 and the movable part 12.

The body 38 is made of a deformable material such as an elastomeric material and has parts 38a towards the rotor shaft 5 with an accordion-like structure, that lets the body radially deform and the movable part 12 radially press against the rotor shaft 5 when pressurized gas is introduced into the chamber 40.

The operation of a machine embodying principles of the present invention is apparent from that described and illustrated and is substantially the following.

During normal operation the control valves 20 are closed and the further control valve 24 is open; the emergency seal rings are deactivated and do not carry out any sealing effect.

This lets possible leakages at the control valve 20 facing the tank 16 be discharged via the discharge branch 22.

In case a failure occurs such that no oil or only a reduced amount of oil in supplied into the seal rings 7 (and thus the sealing effect of the seal rings 7 is reduced) an automatic control system 45 drives the control valves 20 to open, and the further control valve 24 to close.

In this configuration gas (such as for example high pressure N₂ contained in the tank 16) is supplied (eventually at a reduced pressure via pressure reducing valve 26) into the pipe 18 and, thus into the chambers 40 of each emergency seal rings 10.

When in the chambers 40 (embodiment of FIG. 5), the high pressure gas makes the side of the body 38 having the metal plate 46 embedded therein to rotate as shown by arrow F and the movable part 12 to axially move towards the rotor shaft 5 (in the embodiment of FIG. 5).

Alternatively (embodiment of FIG. 6), when in the chambers 40, the high pressure gas 41 makes the accordion like structure 38a to extend and the movable portion 12 to radially move towards the rotor shaft 5.

The emergency seal rings then stay in the activated configuration as long as the generator is running out and in safe configuration (i.e., after is has been purged with CO₂ or N₂).

With a security improved sealed electric machine embodying principles of the present invention, costs reduction are possible by reducing the availability time for the power station battery.

Naturally the features described may be independently provided from one another.

In practice the materials used and the dimensions can be chosen at will according to requirements and to the state of the art.

### REFERENCE NUMBERS

1 electric machine
2 casing
3 stator
4 rotor
5 rotor shaft
6 bearings
7 seal rings
8 wipers
10 emergency seal rings
12 movable part of 10
14 emergency seal circuit
16 tank
18 pipe
20 control valves
22 discharge branch
24 further control valve
26 pressure reducing valve
28 safety branch
30 safety valve
32, 34, 36 pressure sensors
38 body of 10
38a part of 38
40 chamber of 10
41 gas
42, 44, 46 metal plates
45 automatic control system
48 metal plate structure
F arrow

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the suited to the particular use contemplated. It is intended that the scope of the invention be defined by the claims appended hereto, and their equivalents. The entirety of each of the aforementioned documents is incorporated by reference herein.

I claim:

1. A security-improved sealed electric machine comprising:
a casing, a stator, a rotor, and a rotor shaft extending out of the casing, the casing housing the stator and the rotor, the rotor being supported by the rotor shaft;
seal rings between the casing and the rotor shaft configured and arranged to seal the casing interior against an environment outside of the casing; and
emergency seal rings between the casing and the rotor shaft having a deactivated configuration during normal operation of the electric machine, in which the emergency seal rings do not seal against the rotor shaft, and an activated configuration in the event of failure of the seal rings, in which the emergency seal rings seal against the rotor shaft.

2. An electric machine as claimed in claim 1, wherein the rotor shaft has two ends, and the emergency seal rings comprise two emergency seal rings, each located at one of the rotor shaft ends.

3. An electric machine as claimed in claim 2, wherein each of said emergency seal rings comprises a movable part that, when the emergency seal ring is activated, can be moved against the rotor shaft to seal against the rotor shaft.

4. An electric machine as claimed in claim 3, further comprising:
an emergency seal circuit configured and arranged to supply a pressurized gas that causes the movable part to move against the rotor shaft.

5. An electric machine as claimed in claim 4, wherein said emergency seal circuit comprises:
a tank containing the pressurized gas and a pipe connecting the tank to the emergency seal rings; and
at least one control valve on said pipe configured and arranged to control the gas supply to the emergency seal rings.

6. An electric machine as claimed in claim 5, wherein the at least one control valve comprises two control valves on said pipe, and further comprising:
a discharge branch connected to the pipe between the two control valves and configured and arranged to discharge gas to the outside of the pipe; and
a third control valve on said discharge branch.

7. An electric machine as claimed in claim 6, further comprising:
a pressure reducing valve between the tank and the two control valves on said pipe.

8. An electric machine as claimed in claim 7, further comprising:
a safety discharge branch connected to a portion of said pipe downstream of the two control valves on said pipe, the safety branch including a safety valve.

9. An electric machine as claimed in claim 7, wherein:
said emergency seal rings each have an annular hollow body defining a chamber and which comprises the movable part; and
the chamber is in fluid communication with the pipe so that gas from the tank can be fed into the chamber to activate the movable part and move the movable part towards the rotor shaft.

10. An electric machine as claimed in claim 9, wherein the annular hollow body is made of a deformable material having a reinforced structure embedded therein.

11. An electric machine as claimed in claim 10, wherein the hollow annular body comprises a part facing the rotor shaft which includes an accordion structure and the reinforcing structure is embedded in sides of the hollow annular body not including the accordion structure.

12. An electric machine as claimed in claim 5, further comprising:
an automatic control system configured and arranged to drive the at least one control valve to open if a failure at the seal rings occurs.

13. An electric machine as claimed in claim 6, further comprising:
an automatic control system configured and arranged to drive the at least one control valve to open if a failure at the seal rings occurs, and to drive the third control valve to close if a failure at the seal rings occurs.
